(19) United States
(12) Patent Application Publication
(10) Pub. No.: US 2024/0077348 A1
(43) Pub. Date: Mar. 7, 2024

(54) MEASURING MULTIPHASE FLOWS FROM WELLS

(71) Applicant: Saudi Arabian Oil Company, Dhahran (SA)

(72) Inventors: Ramsey James White, Abqaiq (SA); Mohammed S. Al-Mulfi, Dhahran (SA); Mostafa M. El-Baradie, Abqaiq (SA); Mohammed A. Al-Huraifi, Al-Qatif (SA)

(21) Appl. No.: 17/929,974

(22) Filed: Sep. 6, 2022

(51) Int. Cl. G01F 1/74; E21B 43/34; E21B 47/07; G01F 15/02

(52) U.S. Cl. CPC G01F 1/74; E21B 43/34; E21B 47/07; G01F 15/022; E21B 2200/20

(57) ABSTRACT

A multiphase well fluid system includes water-cut meters configured for installation in a pipeline network and for measurement of a water cut percentage of respective multiphase well fluids from respective wells into the pipeline network to a gas oil separation plant (GOSP); temperature sensors configured for installation in the pipeline network and for measurement of a temperature of the multiphase well fluid flows from the wells into the pipeline network to the GOSP; and a control system configured to perform operations that include generating a digital twin of the wells and the pipeline network; and determining a virtual flow rate for at least one fluid phase of each of the multiphase well fluids from the wells with the generated digital twin, the measured water-cut percentages, and the measured temperatures.

### TECHNICAL FIELD

The present disclosure describes systems and methods for measuring multiphase flows from wells and more particularly, measuring well flows that include oil, gas, and water.

### BACKGROUND

Testing of oil well multiphase flows is conducted periodically for each individual well (for example, among many wells in a field) to determine the individual well's gas flow rate, oil flow rate, and water flow rate. Measurements are conventionally conducted using a high-pressure test trap (HPTT), which is a pressure vessel with flow measurement devices on gas and liquid lines) or a multiphase flow meter (MPFM), which is a flow meter capable of measuring all phases in one device. The HPTT and MPFM are typically located in a gas-oil separation plant (GOSP) at a dedicated testing manifold. To test a well, the well is connected to the testing manifold, either directly from a flow line to the testing manifold if the flow line is tied directly to a GOSP production header, or by connecting the flow line through a test line at a remote location in the field if the flow line is typically connected to a trunk line.

### SUMMARY

In an example implementation, a multiphase well fluid system includes a plurality of water-cut meters configured for installation in a pipeline network and for measurement of a water cut percentage of a respective plurality of multiphase well fluids from a respective plurality of wells into the pipeline network to a gas oil separation plant (GOSP); a plurality of temperature sensors configured for installation in the pipeline network and for measurement of a temperature of the respective plurality of multiphase well fluid flows from the respective plurality of wells into the pipeline network to the GOSP; and a control system communicably coupled to the plurality of water-cut meters and the plurality of temperature sensors, and configured to perform operations. The operations include generating a digital twin of the plurality of wells and the pipeline network; and determining a virtual flow rate for at least one fluid phase of each of the plurality of multiphase well fluids from the respective plurality of wells with the generated digital twin, the plurality of measured water-cut percentages, and the plurality of measured temperatures.

In an aspect combinable with the example implementation, the operation of generating the digital twin of the plurality of wells and the pipeline network includes generating the digital twin of the plurality of wells and the pipeline network based on at least one well parameter and at least one pipeline network parameter.

In another aspect combinable with any of the previous aspects, the at least one well parameter includes at least one of: well completion choke settings, reservoir pressure, production index, or PVT data; and the at least one pipeline network parameter includes at least one of pipeline diameters, pipeline lengths, pipeline pressure losses, or flow control device pressure loss data.

Another aspect combinable with any of the previous aspects further includes at least one flow meter configured for installation on a fluid output from the GOSP and to measure a flow rate of a fluid phase of a plurality of fluid phases of a separated well fluid output from the GOSP.

In another aspect combinable with any of the previous aspects, the at least one flow meter includes: a first flow meter configured for installation on a gas output from the GOSP; and a second flow meter configured for installation on an oil output from the GOSP.

In another aspect combinable with any of the previous aspects, the at least one flow meter further includes: a third flow meter configured for installation on a water output from the GOSP.

In another aspect combinable with any of the previous aspects, the operations further include: comparing the plurality of determined virtual flow rates with the a mass or volumetric fluid flow from the GOSP that includes a measured gas flow rate from the first flow meter, a measured oil flow rate from the second flow meter, and a measured water flow rate from the third flow meter; and validating the plurality of determined virtual flow rates based on the comparison.

In another aspect combinable with any of the previous aspects, the operations further include, based on the comparison, adjusting the generated digital twin.

In another example implementation, a method includes measuring a water cut percentage of each of a plurality of multiphase well fluids from a respective plurality of wells with a plurality of water-cut meters installed in a pipeline network between the plurality of wells and a gas oil separation plant (GOSP); measuring a temperature of each of the plurality of multiphase well fluids from the respective plurality of wells with a plurality of temperature sensors installed in the pipeline network between the plurality of wells and the GOSP; generating, with a control system communicably coupled to the plurality of water-cut meters and the plurality of temperature sensors, a digital twin of the plurality of wells and the pipeline network; and determining, with the control system, a virtual flow rate for at least one fluid phase of each of the plurality of multiphase well fluids from the respective plurality of wells with the generated digital twin, the plurality of measured water-cut percentages, and the plurality of measured temperatures.

In an aspect combinable with the example implementation, generating the digital twin of the plurality of wells and the pipeline network includes generating, with the control system, the digital twin of the plurality of wells and the pipeline network based on at least one well parameter and at least one pipeline network parameter.

In another aspect combinable with any of the previous aspects, the at least well parameter includes at least one of: well completion choke settings, reservoir pressure, production index, or PVT data; and the at least one pipeline network parameter includes at least one of pipeline diameters, pipeline lengths, pipeline pressure losses, or flow control device pressure loss data.

Another aspect combinable with any of the previous aspects further includes measuring, with at least one flow meter installed on a fluid output of the GOSP, a flow rate of a fluid phase of a plurality of fluid phases of a separated well fluid output from the GOSP.

In another aspect combinable with any of the previous aspects, measuring includes: measuring a first flow rate of a gas output from the GO SP with a first flow meter; and measuring a second flow rate of an oil output from the GOSP with a second flow meter.

In another aspect combinable with any of the previous aspects, measuring further includes measuring a third flow rate of a water output from the GOSP with a third flow meter.

Another aspect combinable with any of the previous aspects further includes comparing, with the control system, the plurality of determined virtual flow rates with the a mass or volumetric fluid flow from the GO SP that includes a measured gas flow rate from the first flow meter, a measured oil flow rate from the second flow meter, and a measured water flow rate from the third flow meter; and validating, with the control system, the plurality of determined virtual flow rates based on the comparison.

Another aspect combinable with any of the previous aspects further includes, based on the comparison, adjusting, with the control system, the generated digital twin.

In another example implementation, a computer-implemented method includes identifying, with one or more hardware processors of a control system, a measured water cut percentage of each of a plurality of multiphase well fluids from a respective plurality of wells with a plurality of water-cut meters installed in a pipeline network between the plurality of wells and a gas oil separation plant (GOSP); identifying, with the one or more hardware processors, a measured temperature of each of the plurality of multiphase well fluids from the respective plurality of wells with a plurality of temperature sensors installed in the pipeline network between the plurality of wells and the GOSP; generating, with the one or more hardware processors, a digital twin of the plurality of wells and the pipeline network; and determining, with the one or more hardware processors, a virtual flow rate for at least one fluid phase of each of the plurality of multiphase well fluids from the respective plurality of wells with the generated digital twin, the plurality of measured water-cut percentages, and the plurality of measured temperatures.

In an aspect combinable with the example implementation, generating the digital twin of the plurality of wells and the pipeline network includes generating, with the one or more hardware processors, the digital twin of the plurality of wells and the pipeline network based on at least one well parameter and at least one pipeline network parameter.

In another aspect combinable with any of the previous aspects, the at least one well parameter includes at least one of: well completion choke settings, reservoir pressure, production index, or PVT data; and the at least one pipeline network parameter includes at least one of pipeline diameters, pipeline lengths, pipeline pressure losses, or flow control device pressure loss data.

Another aspect combinable with any of the previous aspects further includes identifying, with the one or more hardware processors, a measured flow rate of a fluid phase of a plurality of fluid phases of a separated well fluid output from the GOSP with at least one flow meter installed on a fluid output of the GOSP.

In another aspect combinable with any of the previous aspects, identifying includes: identifying, with the one or more hardware processors, a measured first flow rate of a gas phase of the separated well fluid output from the GOSP with a first flow meter; and identifying, with the one or more hardware processors, a measured second flow rate of an oil phase of the separated well fluid output from the GOSP with a second flow meter.

In another aspect combinable with any of the previous aspects, identifying further includes identifying, with the one or more hardware processors, a measured third flow rate of a water phase of the separated well fluid output from the GOSP with a third flow meter.

Another aspect combinable with any of the previous aspects further includes comparing, with the one or more hardware processors, the plurality of determined virtual flow rates with the a mass or volumetric fluid flow from the GOSP that includes a measured gas flow rate from the first flow meter, a measured oil flow rate from the second flow meter, and a measured water flow rate from the third flow meter; and validating, with the one or more hardware processors, the plurality of determined virtual flow rates based on the comparison.

Another aspect combinable with any of the previous aspects further includes, based on the comparison, adjusting, with the one or more hardware processors, the generated digital twin.

Implementations of systems and methods for measuring multiphase flows from wells according to the present disclosure can include one or more of the following features. For example, systems and methods for measuring multiphase flows from wells according to the present disclosure can provide real time multiphase flow measurements that can be used to optimize reservoir production/injection strategy and manage water production in a timely manner. As another example, systems and methods for measuring multiphase flows from wells according to the present disclosure can include or provide techniques that facilitate continuous, multiphase flow measurement using more cost-effective measurement devices, digital twins, and data analytics. As a further example, systems and methods for measuring multiphase flows from wells according to the present disclosure can generate a virtual model that uses actual wellhead water cut and temperature measurements and hydraulic simulation to calculate rates of different wells connected to a single production network.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example implementation of a multiphase well fluid testing system according to the present disclosure.

FIG. 2A is a schematic diagram of an example implementation of a well fluid production network that includes multiple wells connected to a gas-oil separation plant according to the present disclosure.

FIG. 2B is a schematic diagram of an example implementation of a portion of a well fluid production network that includes a well connected to a test line and a trunk line to flow wellbore fluid to a gas-oil separation plant according to the present disclosure.

FIG. 3 is a schematic diagram of a workflow to determine multiphase well fluid flows with a digital twin of a well fluid production network according to the present disclosure.

FIG. 4 is a schematic illustration of an example control system according to the present disclosure.

### DETAILED DESCRIPTION

The present disclosure describes example implementations of a multiphase well fluid testing system that can be operated to accurately and efficiently determine flow rates (and in some aspects, other parameters) of separate phases of a multiphase fluid produced from a well (of potentially many wells that are all connected to a gas-oil separation plant, or GOSP). In some aspects, the testing system generates and uses a digital twin of a well fluid production network (in other words, one or more wells and a piping network that connects the one or more wells to a GOSP). For example, in some aspects, the multiphase well fluid testing system can comprise and use the digital twin along with in-line well water-cut and temperature measurement devices to determine individual phase-by-phase fluid flow rates (for example, for oil, gas, and water in the multiphase flow) and validate and reconcile the determined flow rates with further well fluid measurements taken at the GOSP. In some aspects, the well fluid flow rates can be determined and validated in real time, such as while the multiphase fluids are flowing from one or more wells to the GOSP to be processed and separated.

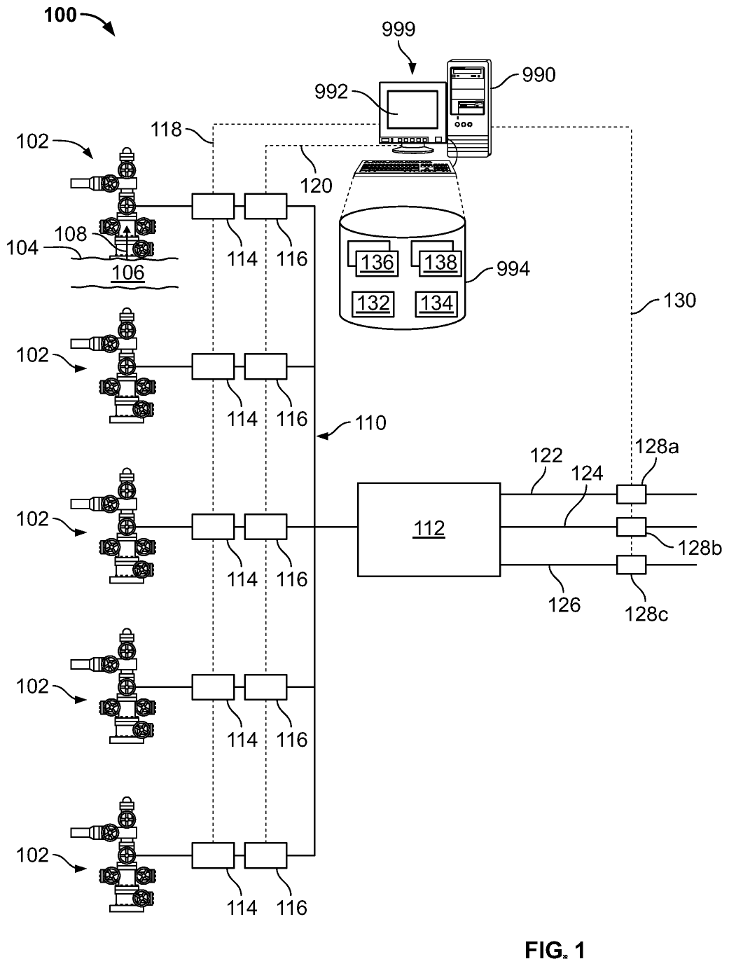

FIG. 1 is a schematic diagram of an example implementation of a multiphase well fluid testing system 100 according to the present disclosure. Multiphase well fluid testing system 100 includes, in this example, wells 102 (with five shown but fewer or greater number of wells also contemplated) that are connected to a GOSP 112 through a piping network 110. Generally, the piping network 110 comprises a number of pipe or conduit sections, valves and other flow control devices, and measurement devices (not all of which are shown) that are connected to carry a flow of a multiphase well fluid from a well 102 to the GOSP 112. Generally, the GOSP 112 operates to separate the phases of the multiphase well fluid into the constituent phases, such as gas, oil, and water (fresh or brine).

As shown in this example, each well 102 comprises a production well on an Earth surface 104 (terranean or water) to produce a multiphase well fluid 108 from a subterranean hydrocarbon reservoir 106. In some aspects, the piping network 110 is connected to a wellhead of each well 102 to circulate the multiphase well fluid 108 from the well 102, into the piping network 110, and to the GOSP 112. The GOSP 112 operates to separate and output a gas output flow 122, a crude oil output flow 124, and a water output flow 126.

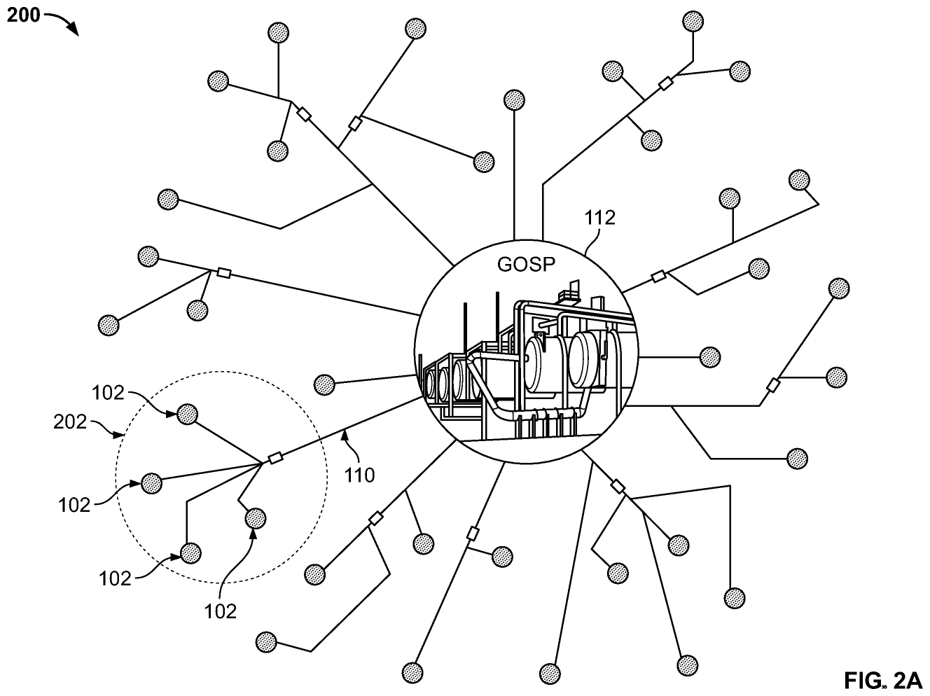

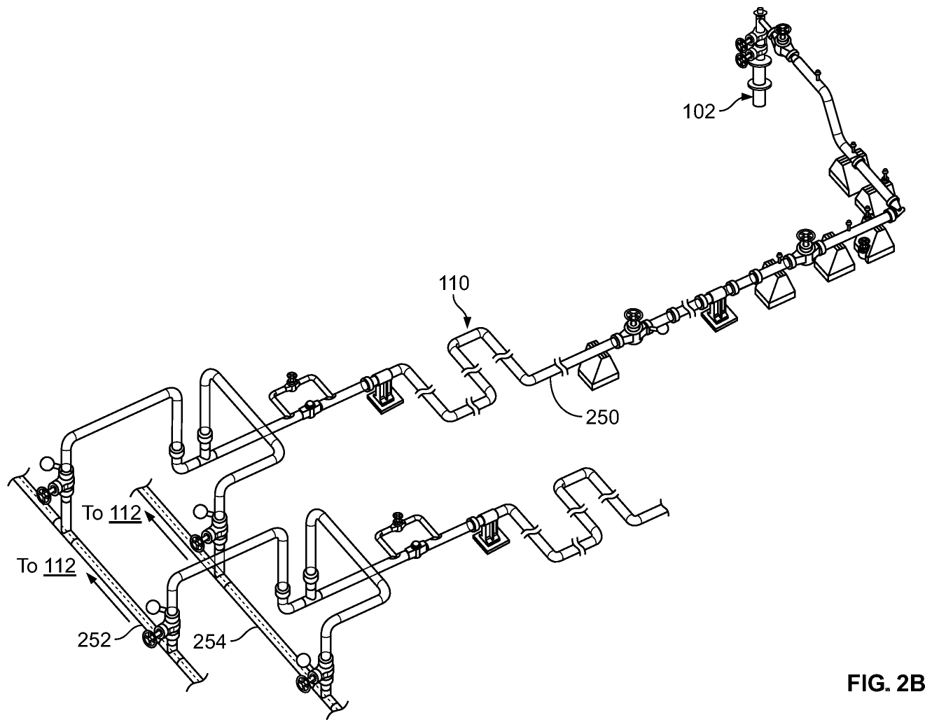

Turning briefly to FIG. 2A, this figure shows a schematic diagram of an example implementation of a well fluid production network 200 that includes multiple wells 102 connected to the GOSP 112. For example, in a typical fluid production network 200, there can be multiple production fields 202 (with one of many referenced). Each production field 202 can include at least one (but usually several) well 102. Within each production field 202, the well(s) 102 are connected to the piping network 110 and thus to the GOSP 112.

Turning to FIG. 2B, this figure is a schematic diagram of an example implementation of a portion of the well fluid production network 200 that includes a well 102 connected with a flow line 250 to a conventional test line 252 and a conventional trunk line 254 to flow wellbore fluid to the GOSP 112. In a conventional testing system and process, the test line 252 is necessary for a conventional testing system to estimate (not accurately in some instances) separate flow rates of oil, gas, and water. For example, to test a well at a GOSP, the process typically involves the following steps: 1. Lining up (for example, operating one or more flow control devices to direct fluid flow) the test line 252 to a production header at the GOSP 112; 2. Lining up the well 102 to the test line 252; 3. Flowing the well 102 for 2-6 hours to flush the test line 252 (for example, depending on the length of the test line 252 to the GOSP 112); 4. Lining up the test line 252 to a test header of the GOSP 112; and 5. Testing the well using the HPPT or MPFM for 8 hrs. The process is laborious and requires frequent opening and closing of manual valves. Furthermore, conventionally a maximum of three wells can be tested in one day. Some wells are retested if further adjustments to choke settings are required. Wells are typically tested once a month, but it can go longer depending on the progress of testing plan for wells on a production priority list.

In example embodiments of the present disclosure, however, the multiphase well fluid testing system 100 integrates particular measurement devices with a digital twin to continuously measure the multiphase flow from wells 102 while eliminating the need for a test line 252. Turning back to FIG. 1, the multiphase well fluid testing system 100 includes a water-cut meter 114 and a temperature sensor 116 installed in the piping network 110 (for example, the flow line 250) between each well 102 and the GOSP 112. Thus, in this example, so as to measure multiphase flows for each well 102, there can be a 1:1 ratio of wells 102 to meter 112 and sensor 116. In some aspects, the waster-cut meter 112 can be an Aquafield water cut-meter from Hammertech AS.

As shown, each water-cut meter 114 is communicably coupled (or measured data is otherwise made available) through a data connection 118 (wired or wireless) to a control system 999 that is part of the multiphase well fluid testing system 100, such as to provide the control system 999 with real time measurements. Alternatively, measurements taken by the water-cut meter 114 (in other words, measurements of percent water of the multiphase well fluid 108) can be saved and later retrieved by or provided to the control system 999. Likewise, each temperature sensor 116 is communicably coupled (or measured data is otherwise made available) through a data connection 120 (wired or wireless) to the control system 999, such as to provide the control system 999 with real time measurements. Alternatively, measurements taken by the temperature sensor 116 (in other words, measurements of temperature of the multiphase well fluid 108) can be saved and later retrieved by or provided to the control system 999.

In some aspects, the water-cut meters 114 and temperature sensors 116 can be deployed on wells 102 that, for example, include current fiber optic or very small aperture terminal (VSAT) connectivity back to the GOSP 112. For example, the water cut meters 114 and/or temperature sensors 116 can be connected to an existing remote terminal unit (RTU) at each well 102 and the data can be available in both a supervisory control and data acquisition (SCADA) system as well as a proponent plant information (PI) system of the GOSP 112. Alternatively, water-cut meters 114 and temperature sensors 116 can be deployed on wells 102 that, for example, do not include current fiber optic or VSAT connectivity.

As further shown in FIG. 1, the multiphase well fluid testing system 100 includes a gas flow meter 128a installed on the gas output flow 122 to measure a gas flow rate, an oil flow meter 128b installed on the oil output flow 124 to measure an oil flow rate, and a water flow meter 128c installed on the water output flow 126 to measure a water flow rate. The flow meters 128a-128c are communicably coupled (or measured data is otherwise made available) through a data connection 130 (wired or wireless) to the control system 999, such as to provide the control system 999 with real time measurements from these flow meters 128a-128c. Alternatively, measurements taken by the flow meters 128a-128c can be saved and later retrieved by or provided to the control system 999. In some aspects, the multiphase well fluid testing system 100 can include only two of the three flow meters 128a-128c (and, for example, a flow rate of a fluid phase on an output that does not include a flow meter can be determined by mass or volumetric flow rate balances and other data from the GOSP 112). In some aspects, the multiphase well fluid testing system 100 can include only one of the three flow meters 128a-128c (and, for example, flow rates of fluid phases on outputs that do not include a flow meter can be determined by mass or volumetric flow rate balances and other data from the GOSP 112).

Control system 999 comprises a microprocessor-based computing system (in example implementations) that includes a processing device 990, a graphical user interface 992 to display virtual or digital data, and a data store 994 (for example, a non-transitory computer readable media that stores computer-executable instructions as well as data). The data store 994 can store one or more digital twins 136 of the wells 102 and pipeline network 110, well and pipeline data 132, virtual fluid phase flows 134, and validated flow rates 138. In some aspects, the well and pipeline data 132 can include, for example, well completion choke settings, reservoir pressure, productivity index, and PVT data, among other well data. In some aspects, the well and pipeline data 132 can also include pipeline diameters, pipeline lengths, pipeline pressure losses (total or per length), flow control device pressure loss data, and other data. In some aspects, the well and pipeline data 132 can include actual operation conditions of the production system (in other words, the wells 102 and pipeline network 110).

In this example implementation, the processing device 990 generates one or more digital twins 136 based at least in part on well and pipeline data 132. The measured water-cut data and temperature data from the respective water cut meters 114 and temperature sensors 116 (with such water-cut data and temperature data stored in data store 994 or not) can be applied to the digital twin 136 to produce virtual flow rates 134 of each phase of the multiphase well fluid 108 per well 102. In some aspects, the control system 999 can generate the digital twin 136 using, e.g., a steady state multiphase simulation software, for example, PIPESIM, GAP/Prosper, or other digital twin software package.

In an example operation of the multiphase well fluid testing system 100, multiphase well fluid 108 is produced from one, some, or all of the wells 102 into the piping network 110. As the produced multiphase well fluid 108 circulates through the piping network 110 (for example, through respective flow lines 250 and into the trunk line 254), the water-cut meter 114 installed in, for instance, each flow line 250, measures a percentage of water in the multiphase well fluid 108 from each well 102. The measured percentage of water for each well 102 is provided to the control system 999 (through data connection 118). Further, as the produced multiphase well fluid 108 circulates through the piping network 110 (for example, through respective flow lines 250 and into the trunk line 254), the temperature sensor 116 installed in, for instance, each flow line 250, measures a temperature of the multiphase well fluid 108 from each well 102. The measured temperature for each well 102 is provided to the control system 999 (through data connection 120).

The example operation also includes generating the digital twin 136 of the wells 102 and piping network 110 using the well and pipeline data 132 using a steady state multiphase simulation software executed by the control system 999. The digital twin 136 is a virtual representation (for example, a computer generated virtual model) of the wells 102 and the piping network 110.

Next in the example operation, the measured percentage of water in the multiphase well fluid 108 for each well 102, and the measured temperature of the multiphase well fluid 108 for each well 102 are applied to the generated digital twin 136 by the control system 999. Based on the generated digital twin and the measured water cut percentage and temperature of the multiphase well fluid 108 from each well 102, the control system 999 determines separate, virtual flow rates for each of the phases of the multiphase well fluid 108 for each well 102, namely, a virtual gas flow rate, a virtual oil flow rate, and a virtual water flow rate. The virtual flow rates determined by the control system 999 can be stored as virtual flow rates 134 of each phase of the multiphase well fluid 108 per well 102.

For example, in this step of the operation, a calibrated, steady, state multi-phase simulation model can accurately simulate pressure, temperature, and flow profile for each component of the pipeline network 110 (for example, the well 102, manifold, or trunk line). Measured temperature (from temperature sensor 114) can be used to determine the operating status of the respective well 102. Real-time water cut measurement from the water-cut meter 112 can be input into the digital twin 136 in order to identify a change of water cut in a timely manner (for example, in real time).

In the example operation, individual, flow rates of the separated gas output flow 122, oil output flow 124, and water output flow 126 from the GOSP 112 are measured by the respective flow meters 128a-128c. Each of the respective flow meters 128a-128c, in some aspects, can be single-phase flow meters, each of which is selected for the particular output flow line on which it is installed. The measured gas output flow 122, oil output flow 124, and water output flow 126 are provided to the control system 999 through data connection 130.

The control system 999, in the example operation, can validate or reconcile the virtual flow rates 134 with the measured gas output flow 122, oil output flow 124, and water output flow 126. For example, the control system 999 can compare a facility output of the GOSP 112, in other words, the gas output flow 122, oil output flow 124, and the water output flow (for example, in real time or over 1 or more days of operation) against the sums of the individual virtual flow rates 134 for gas, oil, and water that are provided to the GOSP 112 through the piping network 110. In, some aspects, mass flow balances can be computed (for example, mass or volume flow into the GOSP 112 against mass or volume flow out of the GOSP 112) by the control system 999, which can then adjust the virtual flow rates 134 and/or digital twin 136 based on discrepancies in the balance of mass or volume flow. In the case of an adjusted digital twin 136, the new digital twin 136 can be then used to determine new virtual flow rates 134. For example, the mass flow balances can be computed and the digital twin 136 can be adjusted by an equation-based advanced data validation and reconciliation packages such as, for instance, VALI by BELSIM.

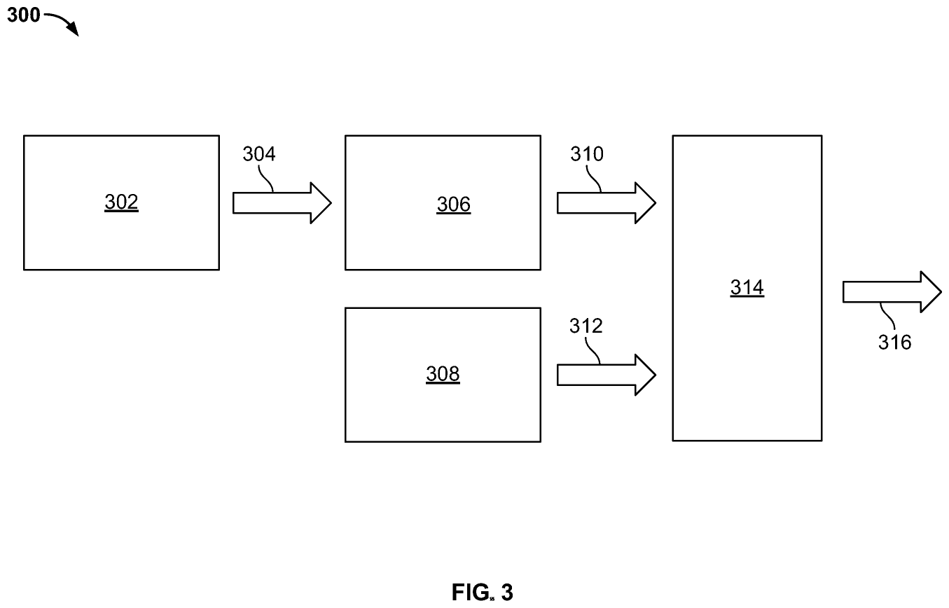

FIG. 3 is a schematic diagram of a workflow 300 to determine multiphase well fluid flows with a digital twin of a well fluid production network according to the present disclosure. In some aspects, for example, the workflow 300 can be implemented by or with the control system 999 of the multiphase well fluid testing system 100 in FIG. 1. Workflow 300 can begin at 302, which includes taking, receiving, and/or identifying field measurements 304 of water cut percentages and temperatures of multiphase well fluids 108 produced from wells 102. The field measurements 304 are provided to step 306 of the workflow 300, which includes implementing a digital twin 136 generated by the well and pipeline data 132. Implementing the digital twin 136 with the field measurements 304 produces simulated (per well 102) phase flow rates 310 for the oil, gas, and water in each of the multiphase well fluids 108. In series or parallel with the implementation step 306, field measurements 308 of the separated output flows from GOSP 112 (in other words, separate gas, oil, and water flows) are taken, received, or identified. Measured or aggregated flows 312 from the GOSP 112 are provided to step 314, which includes validation of the virtual flow rates 134 against the measured or aggregated flow rates 312 from the GOSP 112. Validated virtual flow rates 316 are output from the control system 999, such as to the user interface 992. In some aspects, the validated virtual flow rates 316 can be used in step 306 to generate or adjust the digital twin 136.

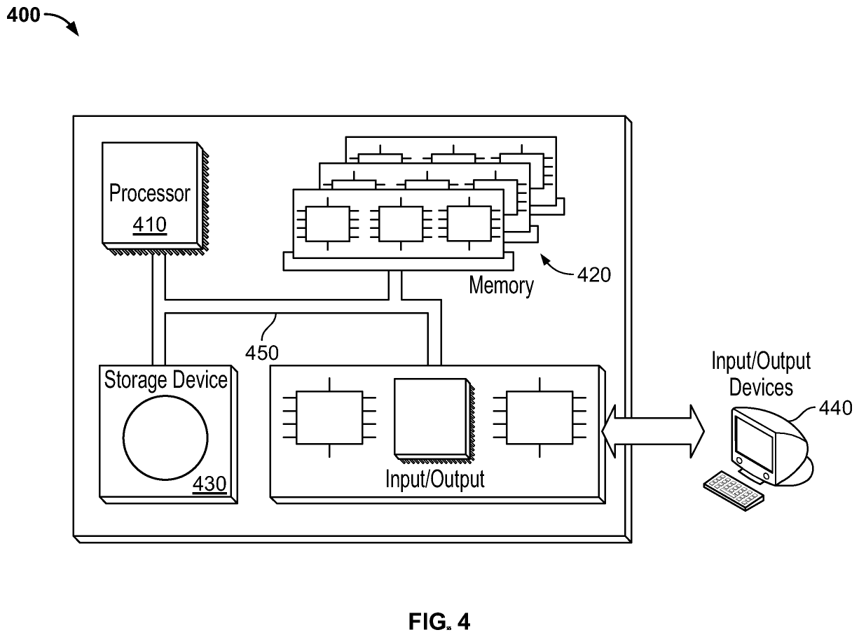

FIG. 4 is a schematic illustration of an example controller 400 (or control system), such as all or a portion of the control system 999 of FIG. 1. For example, all or parts of the controller 400 can be used for some or all of the operations previously described. The controller 400 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 400 includes a processor 410, a memory 420, a storage device 430, and an input/output device 440. Each of the components 410, 420, 430, and 440 are interconnected using a system bus 450. The processor 410 is capable of processing instructions for execution within the controller 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the controller 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the controller 400. In one implementation, the storage device 430 is a computer-readable medium. In various different implementations, the storage device 430 may be a floppy disk device, a hard disk device, an optical disk device, a tape device, flash memory, a solid state device (SSD), or a combination thereof.

The input/output device 440 provides input/output operations for the controller 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A multiphase well fluid system, comprising:
a plurality of water-cut meters configured for installation in a pipeline network and for measurement of a water cut percentage of a respective plurality of multiphase well fluids from a respective plurality of wells into the pipeline network to a gas oil separation plant (GOSP);
a plurality of temperature sensors configured for installation in the pipeline network and for measurement of a temperature of the respective plurality of multiphase well fluid flows from the respective plurality of wells into the pipeline network to the GOSP; and
a control system communicably coupled to the plurality of water-cut meters and the plurality of temperature sensors, and configured to perform operations, comprising:
generating a digital twin of the plurality of wells and the pipeline network; and
determining a virtual flow rate for at least one fluid phase of each of the plurality of multiphase well fluids from the respective plurality of wells with the generated digital twin, the plurality of measured water-cut percentages, and the plurality of measured temperatures.

2. The multiphase well fluid system of claim 1, wherein the operation of generating the digital twin of the plurality of wells and the pipeline network comprises generating the digital twin of the plurality of wells and the pipeline network based on at least one well parameter and at least one pipeline network parameter.

3. The multiphase well fluid system of claim 2, wherein the at least one well parameter comprises at least one of: well completion choke settings, reservoir pressure, production index, or PVT data; and
the at least one pipeline network parameter comprises at least one of pipeline diameters, pipeline lengths, pipeline pressure losses, or flow control device pressure loss data.

4. The multiphase well fluid system of claim 1, further comprising at least one flow meter configured for installation on a fluid output from the GOSP and to measure a flow rate of a fluid phase of a plurality of fluid phases of a separated well fluid output from the GOSP.

5. The multiphase well fluid system of claim 4, wherein the at least one flow meter comprises:
a first flow meter configured for installation on a gas output from the GOSP; and
a second flow meter configured for installation on an oil output from the GOSP.

6. The multiphase well fluid system of claim 5, wherein the at least one flow meter further comprises:
a third flow meter configured for installation on a water output from the GOSP.

7. The multiphase well fluid system of claim 6, wherein the operations further comprise:
comparing the plurality of determined virtual flow rates with the a mass or volumetric fluid flow from the GOSP that comprises a measured gas flow rate from the first flow meter, a measured oil flow rate from the second flow meter, and a measured water flow rate from the third flow meter; and
validating the plurality of determined virtual flow rates based on the comparison.

8. The multiphase well fluid system of claim 7, wherein the operations further comprise, based on the comparison, adjusting the generated digital twin.

9. A method, comprising:
measuring a water cut percentage of each of a plurality of multiphase well fluids from a respective plurality of wells with a plurality of water-cut meters installed in a pipeline network between the plurality of wells and a gas oil separation plant (GOSP);
measuring a temperature of each of the plurality of multiphase well fluids from the respective plurality of wells with a plurality of temperature sensors installed in the pipeline network between the plurality of wells and the GOSP;
generating, with a control system communicably coupled to the plurality of water-cut meters and the plurality of temperature sensors, a digital twin of the plurality of wells and the pipeline network; and
determining, with the control system, a virtual flow rate for at least one fluid phase of each of the plurality of multiphase well fluids from the respective plurality of wells with the generated digital twin, the plurality of measured water-cut percentages, and the plurality of measured temperatures.

10. The method of claim 9, wherein generating the digital twin of the plurality of wells and the pipeline network comprises generating, with the control system, the digital twin of the plurality of wells and the pipeline network based on at least one well parameter and at least one pipeline network parameter.

11. The method of claim 10, wherein the at least well parameter comprises at least one of: well completion choke settings, reservoir pressure, production index, or PVT data; and
the at least one pipeline network parameter comprises at least one of pipeline diameters, pipeline lengths, pipeline pressure losses, or flow control device pressure loss data.

12. The method of claim 9, further comprising measuring, with at least one flow meter installed on a fluid output of the GOSP, a flow rate of a fluid phase of a plurality of fluid phases of a separated well fluid output from the GOSP.

13. The method of claim 12, wherein measuring comprises:
measuring a first flow rate of a gas output from the GO SP with a first flow meter; and
measuring a second flow rate of an oil output from the GOSP with a second flow meter.

14. The method of claim 13, wherein measuring further comprises measuring a third flow rate of a water output from the GOSP with a third flow meter.

15. The method of claim 14, further comprising:
comparing, with the control system, the plurality of determined virtual flow rates with the a mass or volumetric fluid flow from the GOSP that comprises a measured gas flow rate from the first flow meter, a measured oil flow rate from the second flow meter, and a measured water flow rate from the third flow meter; and
validating, with the control system, the plurality of determined virtual flow rates based on the comparison.

16. The method of claim 15, further comprising, based on the comparison, adjusting, with the control system, the generated digital twin.

17. A computer-implemented method, comprising:
identifying, with one or more hardware processors of a control system, a measured water cut percentage of each of a plurality of multiphase well fluids from a respective plurality of wells with a plurality of water-cut meters installed in a pipeline network between the plurality of wells and a gas oil separation plant (GOSP);
identifying, with the one or more hardware processors, a measured temperature of each of the plurality of multiphase well fluids from the respective plurality of wells with a plurality of temperature sensors installed in the pipeline network between the plurality of wells and the GOSP;
generating, with the one or more hardware processors, a digital twin of the plurality of wells and the pipeline network; and
determining, with the one or more hardware processors, a virtual flow rate for at least one fluid phase of each of the plurality of multiphase well fluids from the respective plurality of wells with the generated digital twin, the plurality of measured water-cut percentages, and the plurality of measured temperatures.

18. The computer-implemented method of claim 17, wherein generating the digital twin of the plurality of wells and the pipeline network comprises generating, with the one or more hardware processors, the digital twin of the plurality of wells and the pipeline network based on at least one well parameter and at least one pipeline network parameter.

19. The computer-implemented method of claim 18, wherein the at least one well parameter comprises at least one of: well completion choke settings, reservoir pressure, production index, or PVT data; and
the at least one pipeline network parameter comprises at least one of pipeline diameters, pipeline lengths, pipeline pressure losses, or flow control device pressure loss data.

20. The computer-implemented method of claim 17, further comprising identifying, with the one or more hardware processors, a measured flow rate of a fluid phase of a plurality of fluid phases of a separated well fluid output from the GOSP with at least one flow meter installed on a fluid output of the GOSP.

21. The computer-implemented method of claim 20, wherein identifying comprises:
identifying, with the one or more hardware processors, a measured first flow rate of a gas phase of the separated well fluid output from the GOSP with a first flow meter; and
identifying, with the one or more hardware processors, a measured second flow rate of an oil phase of the separated well fluid output from the GOSP with a second flow meter.

22. The computer-implemented method of claim 21, wherein identifying further comprises identifying, with the one or more hardware processors, a measured third flow rate of a water phase of the separated well fluid output from the GOSP with a third flow meter.

23. The computer-implemented method of claim 22, further comprising:
comparing, with the one or more hardware processors, the plurality of determined virtual flow rates with the a mass or volumetric fluid flow from the GOSP that comprises a measured gas flow rate from the first flow meter, a measured oil flow rate from the second flow meter, and a measured water flow rate from the third flow meter; and
validating, with the one or more hardware processors, the plurality of determined virtual flow rates based on the comparison.

24. The computer-implemented method of claim 23, further comprising, based on the comparison, adjusting, with the one or more hardware processors, the generated digital twin.
